(19) United States
(12) Patent Application Publication
(10) Pub. No.: US 2008/0071566 A1
(43) Pub. Date: Mar. 20, 2008

(54) Method and system for estimation or determination of a gift

(76) Inventor: Anders Schwartz Corr, Brooklyn, NY (US)

Correspondence Address: Anders Corr, Apt. 2F, 332 Starr St., Brooklyn, NY, 11237, US

(21) Appl. No.: 11/900,247

(22) Filed: Sep. 11, 2007

Related U.S. Application Data
(60) Provisional application No. 60/825,897, filed on Sep. 15, 2006.

(51) Int. Cl. G06Q 10/00; G07G 1/00; G06F 17/30

(52) U.S. Cl. 705/1; 705/10

(57) ABSTRACT

The present invention helps clients select an appropriate range of gift costs and/or gift retailer and/or item depending on key numerical values such as, but not limited to, (1) per person event cost, (2) host income and (3) guest income. The system includes a core mathematical function that utilizes this numerical data and could include network data, for example geographic location and/or language spoken, to output a cost range for a wedding gift. By outputting data about retailers and specific items, the preferred embodiment of the present invention helps a wedding guest estimate a gift within an appropriate price range. Other applications of the invention include applications intended for the host of a wedding or non-wedding event, for example estimation of grocery purchases for a dinner party or the value of the total gifts received as the result of an event.

### BACKGROUND OF THE INVENTION

This application is preceded by a provisional application by the current applicant, Anders Schwartz Corr, for an invention titled “Method and System for Estimation or Determination of a Gift”, U.S. application Ser. No. 60/825,897 with a filing date of Sep. 5, 2006.

Current utilities for estimating or determining a gift include several functions on the World Wide Web (WWW); including functions that in some combination ask the client for a cost range of the gift; binary information about the gift, e.g., whether or not the gift should be practical, sentimental, fun, personalized, romantic, etc., or ask about the relationship of the recipient to the client (parent, child, friend, etc.).

The problem with existing utilities is that they do not help the person doing the estimating or purchasing (hereinafter referred to as the “client”) decide or estimate how much to spend or will be spent on the purchase. They do not use the most crucial numerical information to select the cost range and/or the appropriate retailer or item. In the preferred embodiment of the present invention choosing or estimating the proper cost range of a wedding gift, such crucial numerical information includes data on recipient and client income, and per-person event cost.

### BRIEF SUMMARY OF THE INVENTION

The present invention helps clients select an appropriate range of gift costs and/or gift retailer and/or item depending on key numerical values such as, but not limited to, (1) per person event cost, (2) host income and (3) guest income. The present invention is a system that includes a core mathematical function that utilizes this numerical data and could include network data, for example geographic location and/or language spoken, to output a proper cost range for a wedding gift. By outputting data about retailers and specific items, the preferred embodiment of the present invention helps a client estimate a gift within an appropriate price range. This is an application of the invention to a client who is a guest at an event. Other applications of the invention include applications intended for the host of the event, for example, grocery purchases for dinner parties, in which client input would include (1) desired per-person event cost, (2) host income, and (3) guest incomes. The host of an event can also use the utility to estimate the value of the total gifts received as the result of an event; for example, a bride and groom could input their own income, and the income of all their guests, as well as, the per-person event costs to estimate the number and monetary magnitude of gifts.

### BRIEF DESCRIPTION OF THE SEVERAL VIEWS OF THE DRAWING

FIG. 1 depicts the initial client interface with the invention. The client inputs data on the per-person costs of the event, the host's income, the guest's income, and then indicates, by pressing a “Go!” button or otherwise, that the client wishes to receive information, for example an appropriate range or point estimate for a gift, from the invention.

FIG. 2 depicts one manifestation of tie type of information returned by the invention, including an upper bound on the cost of the appropriate gift, a lower bound on the cost of the appropriate gift, and a button “Show Gifts!” that brings the client to gift purchasing pages.

FIG. 3 depicts the core mathematical function of the invention gathering data from both the client and broader network information such as the client's language and geographic location. The function causes the server to output purchasing data and refer the client to sales partners. The server is powered by a server engine, and includes input and output pages.

### DETAILED DESCRIPTION OF THE INVENTION

The present invention is a method and system for deciding a range of gift costs using client and recipient income and per-person event cost (hereafter referred to as “client data”) with or without a communications network that provides the server system with geographic, other locational, cultural, and other data as an artifact of network communication (data hereinafter referred to as “network data”).

In the preferred embodiment on the WWW, a client inputs client data into a server system which then uses a mathematical function to determine an optimal range of a wedding gift cost (hereinafter referred to as “gift data”). The server system could combine the client data with other data, e.g., network data, as inputs to a mathematical function that outputs gift data to the client system. Other outputs of the invention could include referrals to specific retailers and/or suggestions of particular appropriate items.

In the preferred embodiment, after viewing the cost range the client has an option to adjust the suggested cost range, then choose whether to receive information about particular gifts and/or sellers (hereinafter referred to as “purchasing data”). If the client does choose to receive purchasing data, then the server system outputs purchasing data to the client system.

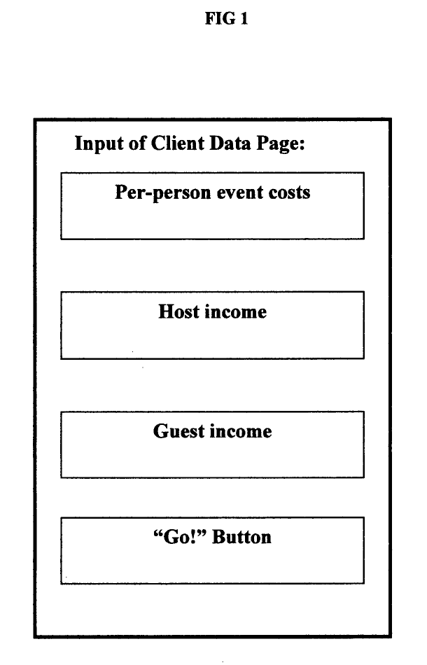

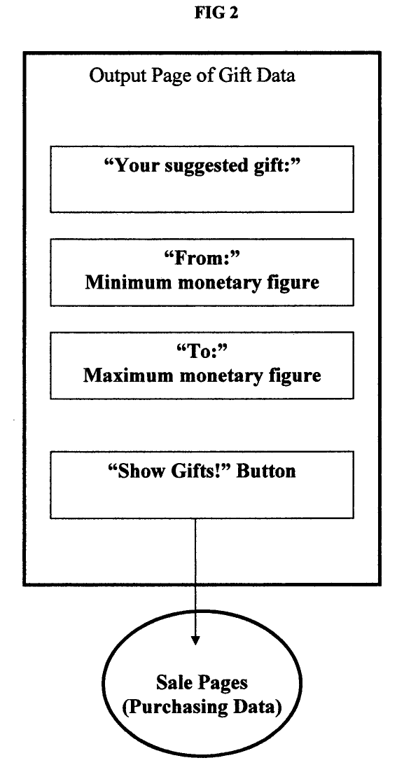

FIGS. 1 to 3 illustrate one particular manifestation of the present invention, as configured for the WWW. FIG. 1 illustrates an input page where the client inputs. client data. Under this manifestation of the invention, the output page (FIG. 2) is delivered to the client when the client pushes the “Go!” button on the input page.

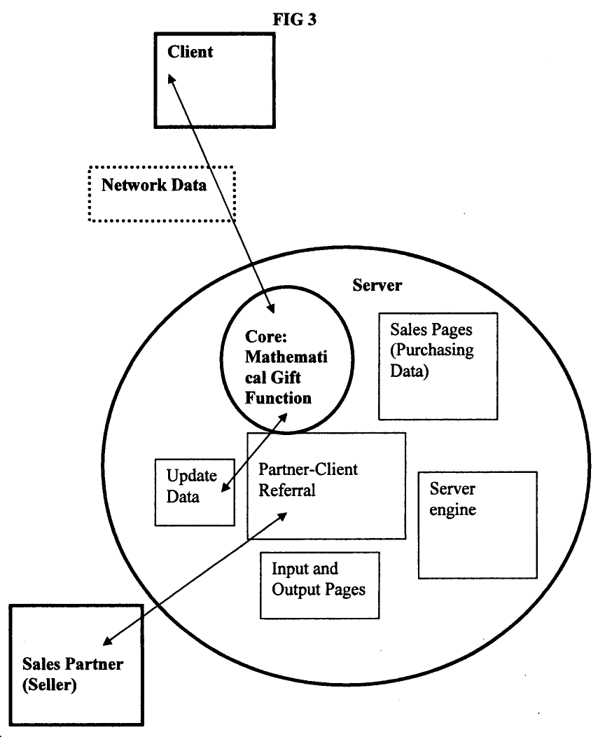

The output page includes gift data, and a button “Show Gifts!” When the client pushes the “Show Gifts!” button, the client is taken to, in this particular manifestation of the invention, a third web page with purchasing data at which the client may purchase suggested gifts, or link to partner sales pages. FIG. 3 shows the interaction of the various systems, including the client system (in the preferred embodiment, a client computer linked via the internet to the server system), partner systems (in the preferred embodiment, partner server systems), a server system, network data, and the core mathematical function.

The preferred embodiment of the core mathematical function is nonlinear and uses client and network data to determine (1) gift data, (2) purchasing data, and (3) sales partners who can provide the client and/or recipient with desired gifts. For the United States, one initial core mathematical function is:
a=b/3+b(m/750+Exp[−r])
x=3a/2
n=a/2

Where a is the average gift value, b is per-person event costs, m is the maximum gift value set by the programmer for a particular geographic region (the United States in this case), r is guest income divided by host income, x is the maximum suggested gift value, and n is the minimum suggested gift value. However, this mathematical function would change according to geographic, linguistic, and other network data.

In the preferred embodiment of the invention, the server collects information on actual gifts purchased and correlates these with client data, network data, gift data, and purchasing data to create a data-set (hereinafter referred to as “update data”). The update data is periodically, for example weekly or monthly, analyzed by a statistician to update the core mathematical function. This use of the update data to improve the core mathematical function will better serve the client.

Although the invention has been described using inputs of “per-person event cost”, one skilled in the art will know that inputs could include “per-plate catering costs”, “per-plate costs”, or separate input fields for number of attendees and total cost of event, and still describe the same essential invention. Likewise, one skilled in the art will recognize that this invention applies to multiple types of delivery system through which information can be transferred from client to company. In addition to the delivery system described herein (the WWW), this invention can be delivered via television, telephone, radio, sales representative, or any other bi-directional communications system.

1. A method and system for assisting to make a purchase decision when the client does not know how much to spend, to which retailer to go, and/or which item to purchase.

2. A method and system of claim 1 that uses a mathematical algorithm to calculate the appropriate range of expenditure.

3. A method and system of claim 1 as designed for wedding gift purchases.

4. A method and system of claim 1 that includes per-person, event costs, host income and/or guest income as inputs.

5. A method and system of claim 1 that uses per-person event costs, host income, guest income and/or additional data, such as network data, as inputs to refine the output.

6. An algorithm used to determine the range of cost for a wedding gift.

7. The algorithm of claim 6 that includes per-person event costs, host income and/or guest income as inputs.

8. The algorithm of claim 6 that uses per-person event costs, host income, guest income and/or additional data, such as network data, to refine the output.

9. A method and system for assisting event hosts in estimating the number and amount of gifts to expect when a host does not know how much guests will spend, to which retailers they will go and/or which items they will purchase.

10. A method and system of claim 9 that uses a mathematical algorithm that calculates the likely range of expenditures.

11. A method and system, of claim 9 as designed for wedding gift purchases.

12. A method and system of claim 9 that includes per-person event costs, host income and/or guest income as inputs.

13. A method and system of claim 9 that uses per-person event costs, host income, guest income and/or additional data, such as network data, to refine the output.

14. An algorithm used to estimate the number and cost of gifts likely to be received by a host.

15. The algorithm of claim 14 that includes per-person event costs, host income, number of guests, and/or guest incomes as inputs.

16. The algorithm of claim 14 that uses per-person event costs, host income, number of guests, and/or guest incomes, and also additional data, such as network data, to refine the output.
